(19) United States
(12) Patent Application Publication
(10) Pub. No.: US 2018/0014548 A1
(43) Pub. Date: Jan. 18, 2018

(54) DOUGH COMPOSITIONS HAVING REDUCED CARBOHYDRASE ACTIVITY

(71) Applicant: General Mills, Inc., Minneapolis, MN (US)

(72) Inventors: David J. Domingues, Plymouth, MN (US); Scott Kackman, New Hope, MN (US); Susan H. Messick, Lakeville, MN (US)

(73) Assignee: General Mills, Inc., Minneapolis, MN (US)

(21) Appl. No.: 15/210,569

(22) Filed: Jul. 14, 2016

(51) Int. Cl. A21D 8/04; A21D 2/18; A21D 2/26; A21D 10/02

(52) U.S. Cl. CPC A21D 8/047; A21D 10/025; A21D 2/186; A21D 2/26

(57) ABSTRACT

Described are raw, yeast-containing dough compositions, packaged products containing the dough, and related methods, wherein the amount or rate of carbon dioxide released by the dough during refrigerated storage is limited, reduced, or controlled.

### FIELD OF THE INVENTION

The invention relates to refrigerator-stable, raw, yeast-containing dough compositions, packaged products containing the dough, and related methods.

### BACKGROUND

Many dough products are prepared for commercial sale as refrigerated, packaged dough products that exhibit storage stability at refrigerated conditions and that can be prepared by a consumer upon removing the dough from the package and baking the dough with little or no additional preparation. Such refrigerator-stable dough products can be very desirable to consumers because of their high level of convenience.

Commercially refrigerated packaged dough products include a wide range of different dough types. Examples include doughs sometimes referred to in the baking arts as “under-developed” or “undeveloped doughs,” which include cookies, cakes, biscuits, scones, and batters. Often these types of doughs include chemical leavening agent, as opposed to yeast as a leavening agent. Other types of doughs include “developed” doughs such as breads and bread-like products including French bread, white or whole wheat bread, bread sticks, baguettes, bread rolls, pizza dough, cinnamon rolls, raised donuts, and other products having developed dough properties. Developed doughs often include yeast as the primary or only leavening agent.

Yeast is designed to metabolize carbohydrates in a dough in a fermentation step, converting oxygen and sugar present in the dough into reaction products that include water, carbon dioxide, and various other metabolites that give yeast-leavened breads their characteristic flavor and aroma. The carbon dioxide, which is gaseous, causes the dough to expand or “rise,” to give the bread a light and spongy texture. The metabolism of carbohydrates by the yeast also affects the gluten network of a dough in a manner that affects the rheology of the raw dough, generally strengthening the dough structure.

In the presence of water, suitable nutrients, and at conditions that are generally present in preparing a refrigerated dough composition from its ingredients yeast will grow and ferment. Accordingly, yeast begin producing carbon dioxide and other metabolites as soon as yeast, flour, and water are initially combined to begin forming a dough. The yeast remain active during preparation of the dough, and generally are not completely deactivated or killed until exposed to baking conditions. And, though not desired, the yeast are generally capable of producing carbon dioxide after the dough is placed in a commercial package, and during transportation, storage, and sale of a dough as a packaged dough product at temperatures above the freezing point of the dough product.

Carbon dioxide produced by yeast in a dough held in a closed package can create problems such as an undesired increase in volume of the dough in the package, as well as gaseous carbon dioxide being released into the package interior, e.g., into headspace atmosphere surrounding the dough. For a commercial packaged dough product that is packaged and then transported and presented for sale, carbon dioxide production by ingredients of the dough can be especially undesirable. A high level of carbon dioxide produced by the dough for the days or weeks after preparation is not acceptable due to the potential dimensional instability of the dough product in the form of an unacceptable amount of expansion of the dough or the package.

A vent can be included in the package to allow gaseous carbon dioxide to escape the package interior, thus preventing buildup of gas within the package and an increase in size of the package during refrigerated storage. But carbon dioxide produced within the dough will cause the dough itself to expand in size within the package. Some amount of dough expansion of the packaged dough product may be commercially acceptable, but many types of packaged doughs should maintain a relatively stable size and shape throughout a refrigerated shelf-life, to meet consumer expectations.

Types of packages that have been used or proposed for use with various yeast-leavened refrigerated packaged dough products include thermally molded or “form-fill” containers made of polymeric film, flexible pouches, and the like. These may be vented, and may include an amount of extra space at the interior of the package (i.e., headspace) in addition to the amount of internal space needed to contain the dough. In this way, carbon dioxide production by the dough and potential expansion of the dough volume during refrigerated storage can be accommodated. The package may remain non-pressurized during transportation and presentation for sale.

Practitioners in the dough and baking arts have researched yeast-leavened dough formulations in efforts to produce dough formulations that can be packaged, refrigerated, frozen, or Bakery-style dough products (which are baked without ever being placed in a package), that produce controlled or reduced amounts of carbon dioxide. Some formulations contain yeast that exhibit limited or controlled carbon dioxide production. Certain yeasts exhibit reduced activity at refrigerated storage temperature (e.g., “low temperature inactive” yeast). Other yeasts, referred to as “substrate limited yeasts,” are incapable of metabolizing certain types of sugars, such as maltose, and can be included in a dough formulation along with a controlled amount non-maltose sugars to reduce or limit the amount of carbon dioxide that is produced by the yeast. One such strain of yeast is incapable of metabolizing maltose, and is referred to as “maltose-negative” (or MAL−) yeast. See, e.g., U.S. Pat. Nos. 5,385,742; 5,540,940; and 5,571,544, the entireties of which are incorporated herein by reference. In alternate formulations, yeast may be replaced as the main leavening agent in a dough by chemical leavening agents that exhibit reduced or controlled activity (and carbon dioxide production) during refrigerated shelf-life; in these formulations, the amount of active yeast can be reduced.

But while certain types of yeast or chemical leavening ingredients in a raw dough may be useful to effect some level of control of the amount of carbon dioxide produced by the yeast, there remains a need for new yeast-leavened dough formulations that produce even lower amounts of carbon dioxide, particularly doughs that produce a reduced amount carbon dioxide during a refrigerated shelf life, so that the dough can be sold as a packaged raw dough product having dimensional stability.

### SUMMARY

Various methods have been used in the past to control carbon dioxide production in raw, yeast-leavened dough compositions. Some approaches have focused on the yeast by researching yeast strains that exhibit reduced or controlled activity at refrigerated conditions or based on the presence or absence of certain other dough ingredients (specific sugars). But while such specialized yeasts may reduce the amount of carbon dioxide produced in a raw dough relative to a more conventional types of yeast, the reduction may not be sufficient to achieve a needed low level of carbon dioxide production, and dough expansion, for a packaged refrigerated dough product. Doughs that include substrate-limited yeast, when used in a raw dough along with other typical or standard dough ingredients such as a conventional flour or starch ingredient, can still produce a more-than-insubstantial amount of carbon dioxide after the dough is placed in a package.

Typical dough ingredients, particularly flour and starch ingredients, include certain types of enzymes that can react with “damaged starch” to produce sugars. The sugars (“substrate sugars”) that may be produced by the enzymes and the damaged starch may be useful for yeast to produce carbon dioxide. The sugars may include maltose and non-maltose sugars, e.g., sucrose, glucose, fructose, i.e., “substrate sugars” that may be metabolized by even substrate-limited (e.g., maltose-negative (MAL−)) yeast to produce carbon dioxide and other metabolites.

The typical form of starch in a starch ingredient or a flour is a starch granule. Another form of starch that is also usually present is “damaged starch,” which refers to low molecular weight starch fragments that have become separated from starch granules. While starch molecules that are part of a starch granule are not easily reacted with an enzyme, damaged starch molecules that have been separated from the starch granules, in the presence of water, are more easily accessed by a carbohydrase enzyme (e.g., amylase), and can be converted into simple sugars. Many flours, and starch ingredients, include amounts of damaged starch.

In addition, many flours commonly used in dough formulations include carbohydrase enzymes such as various types of amylases. As a result, raw dough made from many typical dough ingredients, and with substrate-limited yeast, will still produce carbon dioxide after the dough is prepared; the amylase enzymes (e.g., from the flour) will convert the damaged starch (e.g., from the flour, starch ingredient, or elsewhere) into non-maltose sugars that can be metabolized by the substrate-limited yeast to produce carbon dioxide. If the dough is contained in a package intended for commercial sale, the amount of carbon dioxide produced even by the substrate-limited yeast can be sufficient to cause an unacceptable amount of expansion of the packaged dough during a multi-week refrigerated shelf life.

The present invention involves a novel method of controlling carbon dioxide production in a refrigerated dough after the dough is prepared, such as in a packaged refrigerated dough during a multi-week period of refrigeration for commercial transport and sale. The invention relates to using a substrate-limited yeast to control the amount of carbon dioxide produced in a raw dough, but additionally features the present discovery that the amount of carbon dioxide produced by a substrate-limited yeast during refrigerated storage can be further controlled by limiting the amount of substrate sugars that will be produced by carbohydrase (e.g., amylase) enzyme and damaged starch in the dough during such a period of refrigeration. This control of available substrate sugars in the raw dough during refrigerated storage involves, as discovered by Applicant, the use of dough ingredients that contain a low amount of active carbohydrase enzyme (e.g. amylase) along with a low amount of damaged starch.

The invention is a result of Applicant's discovery that, while a substrate-limited yeast strain may achieve a somewhat reduced amount of carbon dioxide production in a raw dough, especially during and soon after the dough is initially prepared from its ingredients, the dough will continue to produce carbon dioxide after dough preparation, e.g., during refrigeration, and the amount of carbon dioxide produced during refrigeration may be too high for the dough to be sold commercially as a packaged dough product having a desired extended (e.g., multi-week) refrigerated shelf life. Carbon dioxide can still be produced in the dough during extended refrigeration, even by substrate-limited (e.g., maltose negative) yeast, because amylase enzymes in the dough, operating on damaged starch, continue to produce an ongoing supply of non-maltose sugars that can be converted to carbon dioxide by the substrate-limited yeast.

Accordingly, a dough as described can include a reduced level of active carbohydrase (e.g., amylase) enzymes, to exhibit a reduced carbohydrase (e.g., amylase) activity, and a reduced amount of damaged starch.

Reduced levels of active carbohydrase enzyme can be achieved by use of a flour component that includes a reduced amount of active carbohydrase enzyme, e.g., amylase. Examples include flours that are specifically treated, refined, or processed to either inactivate enzymes that are native to a flour grain, such as wheat grain, or to separate the carbohydrase enzymes from the flour grain during milling to produce a flour that contains desired relative amounts of starch, protein, and other constituents of a flour grain, but a reduced amount of carbohydrase enzyme. Reduced enzyme activity, e.g., reduced amylase activity, in a raw dough, can be identified by various known techniques, such as by use of known assay measurement techniques and apparatus.

A reduced level of damaged starch in a raw dough can be achieved by use of a flour component that includes a reduced level of damaged starch. The flour component can include flour that includes protein, starch (in the form of starch granules) and that is processed, treated, refined, or the like, to remove an amount of the damaged starch that would otherwise be present. Alternately, a reduced level of damaged starch can be provided in a raw dough by replacing a portion or all of a typical flour ingredient with a flour component that is a combination of a starch ingredient and a protein ingredient, wherein the starch ingredient is a purified or isolated starch ingredient that contains a reduced level of damaged starch.

The result is a raw dough that produces a reduced or controlled level of carbon dioxide subsequent to the dough's preparation, especially during weeks following preparation, such as during a time when the dough is contained in a package for commercial sale. The dough will produce an amount of carbon dioxide during the time of production, and shortly thereafter, by the maltose-negative yeast converting non-maltose sugars in the dough to carbon dioxide. These non-maltose sugars may be present in the dough ingredients while the dough is being prepared. After the initial supply of substrate sugars has been metabolized and used up by the yeast (e.g., MAL− yeast), however, the amount of new substrate sugars that will be produced within the dough by carbohydrase enzyme and damaged starch is controlled, controlling the availability of any additional supply of substrate sugars that may become available within the dough to be metabolized by the substrate-limited yeast during refrigerated storage.

Preferred dough embodiments exhibit a substantially reduced amount of carbon dioxide production after preparation, especially during days or weeks of refrigerated storage. The reduced amount of carbon dioxide produced can be measured by known techniques. By one measure, the dough can experience a limited level of expansion after preparation, e.g., when contained in a package. By this measure, examples of doughs described herein may increase in raw specific volume to a volume that is not more than two times the volume of the raw dough when the raw dough was placed in the package, e.g., to a volume that is not more than 2.0, 1.8, 1.6, or 1.5 times the volume that the dough had when the dough was placed in the package and the package was closed, e.g., over a period of refrigerated (40 degrees Fahrenheit) storage of at least 10, 20, or 30 days. Measured differently, preferred dough embodiments (either in a package or outside of a package) release not more than 1 cubic centimeter of carbon dioxide per gram of dough, e.g., not more than 0.8, 0.6, or 0.5 cubic centimeters of carbon dioxide per gram of dough during, a period of refrigerated (40 degrees Fahrenheit) storage for at least 10, 20, or 30 day after a final step of preparing the dough (e.g., after a final mixing, shaping, or forming step). The amount of gas released by a dough can be measured by known techniques and equipment, such as by measuring a volume change of a package (e.g., a sealed pouch) over time after placing the dough in a package, by use of a volumetric displacement protocol such as by submerging the package in water.

In one aspect, the invention relates to a packaged raw dough product that includes a dough composition in a package. The dough composition includes: from 30 to 70 weight percent flour component based on total weight dough composition, and active maltose negative yeast in an amount in a range from 0.1 to 5 weight percent based on total weight dough composition and on a dry yeast basis. The raw dough exhibits carbohydrase enzyme activity below 20 Beta amyl-3 U/g.

In another aspect, the invention relates to a raw dough composition. The raw dough includes: from 30 to 70 weight percent flour component based on total weight dough composition. The flour component includes: from 0 to 80 weight percent flour based on total flour component, and from 15 to 100 weight percent composite flour based on total flour component, the composite flour comprising: isolated starch ingredient, and isolated protein ingredient. The dough also includes active maltose negative yeast in an amount in a range from 0.1 to 5 weight percent based on total dough composition. The raw dough exhibits carbohydrase enzyme activity below 20 Beta amyl-3 U/g.

In another aspect, the invention relates to a method of preparing a refrigerated, packaged dough product. The method includes providing a raw dough composition of as described, placing the raw dough composition in a package, and storing the packaged raw dough, with refrigeration, for a refrigeration period of at least 10, 20, or 30 days.

### BRIEF DESCRIPTION OF THE FIGURES

FIG. 1 is a graph of amylase activity for a range of dough compositions.

FIG. 2 is a plot of experimental data relating to carbon dioxide release over a range of dough compositions.

FIG. 3 is a plot of experimental data relating to carbon dioxide release rate over a range of dough compositions.

FIG. 4 is a plot of experimental data relating to carbon dioxide release rate over a range of dough compositions.

FIG. 5 is a plot of experimental data relating to specific volume of a dough over a range of carbon dioxide release rates.

FIG. 6 is a plot of experimental data relating to dough specific volume versus time for doughs having different carbon dioxide release rates.

FIG. 7 is a plot of experimental data relating to dough specific volume versus carbon dioxide release rate, over different refrigeration periods.

FIG. 8 is a plot of experimental data relating to carbon dioxide release rate over a range of dough compositions, and MAL− yeast content.

### DETAILED DESCRIPTION

The invention relates to yeast-leavened doughs that, relative to non-inventive conventional doughs, exhibits a reduced or controlled level of carbohydrase activity and a reduced content of damaged starch. It has been discovered that a reduced level of carbohydrase (e.g., amylase) activity combined with a reduced amount of damaged starch in a dough (as provided by the constituent ingredients used to prepare the dough), can provide a raw yeast-leavened dough that produces a controlled or reduced amount of carbon dioxide after the dough is prepared, especially during days or weeks of refrigerated storage. A dough as described can, for example, be useful in a refrigerated, packaged dough product, because the dough exhibits a useful or highly desired, reduced level of carbon dioxide production during days or weeks of refrigerated storage after the dough is prepared, as measured by the amount of expansion of the raw dough within the package during refrigerated storage.

As used herein, the term “yeast-leavened” refers to a dough composition that is leavened primarily by the production of metabolites of yeast, including gaseous carbon dioxide. A dough will be referred to as yeast-leavened if it meets this criterion, regardless of the state of leavening or expansion of the dough, e.g., whether unleavened, partially leavened (partially proofed), or proofed.

Yeast-leavened dough compositions can be prepared from ingredients generally known in the dough and bread-making arts, typically including flour component (e.g., flour or a substitute in the form of a combination of protein and starch ingredients), a liquid component such as water, yeast as a leavening agent, and optional ingredients such as fat (oil, shortening), salt, sweeteners, dairy products, egg products, processing aids, emulsifiers, particulates, dough conditioners, flavorings, and the like.

In accordance with the present description, a raw dough is prepared to include yeast and other ingredients chosen to effectively and controllably limit the leavening action of the yeast, especially after the dough is initially prepared from its constituent ingredients, by: i) using a substrate-limited yeast, and ii) controlling the amount of substrate sugar capable of being metabolized by the substrate-limited yeast, that is or becomes available in the dough during a period of refrigerated storage. The latter of these two features is accomplished by formulating the dough to contain a desirably low level of active carbohydrase enzyme and by formulating the dough to contain a desirably low amount of damaged starch.

Substrate-limited yeasts, i.e., strains of yeast that do not ferment certain carbohydrates, are known. Often, two different strains of the same species of yeast are unable to ferment the same sugars. Therefore, a strain of yeast may be used in a dough composition that is capable of fermenting only selected sugars. By controlling the total amount of those sugars in a dough composition that contains that type of “substrate-limited” yeast, the amount of fermentation that occurs in the dough can be controlled. Accordingly, yeast-leavened dough as described include “substrate-limited yeast” (e.g., MAL− yeast), to control the amount of carbon dioxide that is produced by the dough. The substrate-limited yeast is incapable of metabolizing certain types of sugars, but is capable of metabolizing other types of sugars. The substrate-limited yeast can be effective to reduce the amount of carbon dioxide produced in a dough composition, especially during preparation and shortly thereafter, because the yeast is less active due to its inability to metabolize certain types of sugars.

Additionally, dough formulations as described are formulated to further control the amount of carbon dioxide produced in the dough, especially subsequent to formation of the dough during refrigerated storage, by controlling the amount of substrate sugars that are produced in the dough during refrigerated storage. Some amounts of substrate sugars are present in a dough or are produced in a dough as the dough is being prepared from ingredients that include water, flour, and starch; i.e., the dough will contain an initial amount of substrate sugars, and those substrate sugars can be metabolized by yeast to produce an initial amount of carbon dioxide, both during preparation and for a time soon after preparation. But, in contrast to non-inventive doughs made from ingredients that contain higher relative amounts of active carbohydrase enzyme and damaged starch, doughs as described herein (containing relatively lower amounts of active carbohydrase enzyme and damaged starch) will produce a reduced or limited amount of additional carbon dioxide after this initial amount is produced during preparation of the dough and soon thereafter. Because of the reduced amount of active carbohydrases (e.g., amylases) in the inventive dough, in combination with the reduced amount of damaged starch, the ingredients of an inventive dough do not continue to produce a supply of additional substrate sugars that can be metabolized by the substrate-limited yeast following preparation of the dough, or may produce a reduced or limited amount of those sugars.

Dough compositions as described, by way of their constituent ingredients, include a controlled or reduced amount of active carbohydrase enzymes, e.g., amylase enzymes, that are capable of reacting with damaged starch in the dough to produce substrate sugars. The dough compositions also include a limited or controlled amount of damaged starch that is available to be processed by the (reduced amount of) carbohydrase enzymes to produce substrate sugars, especially during a period of time after the dough has been prepared. The dough will normally include an initial amount of substrate sugars based on their initial presence in the dough ingredients, e.g., or due to carbohydrase enzyme (present in a dough ingredient) metabolizing an amount of damaged starch (present in a dough ingredient). However, a dough of the invention, containing a reduced or controlled amount of active carbohydrase (e.g., amylase) enzyme in combination with a controlled or reduced amount of damaged starch will produce a reduced or controlled amount of substrate sugars after the dough is prepared. During refrigerated storage, the substrate-limited yeast will be exposed to a relatively lower amount of substrate sugars to metabolize (because less of these are produced by amylase enzyme and damaged starch), resulting in a reduced level of carbon dioxide production by the substrate-limited yeast and substrate sugars.

In certain embodiments, a dough composition as described can contain a reduced level of active amylase enzymes, and, therefore, a reduced level of amylase enzyme activity, as measured by known techniques. A level of active amylase enzymes of a dough, flour, flour component, protein ingredient, starch ingredient, etc., can be measured or quantified by known methods, such as assay methods, one commercially available example being the beta-Amylase (Betamyl® Method; K-BETA3) Procedure for ChemWell® Auto Analyser, as described at https://secure.megazyme.com/files/Data Booklets/K-BETA3_D-CHEMT.pdf. In example embodiments, a dough as described can have a beta amylase activity, (measured within 2 hours after the final step of preparing the dough, and at room temperature, e.g., 70 degrees Fahrenheit) of not greater than 19 Beta amyl-3 Units per gram (U/g), e.g., not greater than 15 Beta amyl-3 U/g, or not greater than 10 Beta amyl-3 U/g.

In these and other embodiments the dough composition can also contain a reduced level of damaged starch, e.g., based on a total amount of starch in the dough composition. For example, the dough composition can contain less than 5, 3, 2, or 1 weight percent damaged starch, based on total starch in the dough composition.

A flour component of the dough can be any suitable flour, combination of two or more flours, or a combination of starch ingredient and protein ingredient with an optional amount of flour. The term “flour” (or “flour ingredient”) is used herein in a manner consistent with its understood meaning in the food and baking arts, generally referring to a dry powder composition prepared by milling or grinding a flour grain, the dry powder composition containing protein and starch from the original flour grain, often in relative amounts that are comparable to the amounts of starch and protein materials in the original flour grain. The flour can be whole grain flour, wheat flour, flour with the bran and/or germ removed, or combinations thereof. Alternately, or additionally, a dough as described can include as some or all of the flour component a “composite” or “synthetic” flour, which refers to a combination of two separated ingredient, an “isolated starch ingredient” in combination with a separate “isolated protein ingredient,” the combination of these ingredients being included in the dough in amounts that are comparable to amounts of starch and protein present in a “flour” or in a wheat grain. As used herein, a “flour component” refers to one or a combination of ingredients that include one or more of: “flour” derived from a flour grain and containing both starch and protein from the flour grain; an isolated starch ingredient (or “starch ingredient” for short); and an isolated protein ingredient (or “protein ingredient” for short).

Typically, a developed dough composition can include between about 30 and about 70 weight percent flour component, e.g., from about 40 to about 60 weight percent flour component, such as from about 45 to 55 weight percent flour component.

Various types and variations of flour ingredients are known, for example based on being prepared from different parts of a flour kernel (e.g., wheat kernel), or based on different types of flour kernels (e.g., wheat kernels) used to produce a flour (which can have an effect on the relative amounts of different components present in the flour, e.g., starch and protein). A wheat kernel contains portions referred to as an endosperm, germ, and bran. The endosperm contains high levels of protein and starch. The wheat germ is rich in protein, fat, and vitamins. And the bran portion is high in fiber. White flour is made from just the endosperm predominantly (some minor or incidental inclusion of other components). Brown flour additionally includes germ and bran. Whole grain flour is prepared from the entire grain, including the bran, endosperm, and germ.

Flour for use in flour component of a dough as described can be any conventional flour (e.g., wheat flour), analog thereof, or any flour having a composition that is consistent with the present description, such as a heat-treated flour or “fancy patent flour” adapted to contain relatively low amounts of active enzyme, damaged starch, or both. Examples include commercially available wheat flours such as those referred to as “all-purpose” flour (“plain” flour), “bread” flour (“strong” flour), whole wheat flour, and the like. Such a flour can include major amounts of starch and protein, and lesser amounts of fat, sugar, vitamins, minerals, and moisture. Typical ranges of certain flour components can be: from 65 to 75 weight percent starch; from about 8 to 15 weight percent protein (e.g., gluten); less than 2 weight percent fat; and small amounts of sugar, fiber, enzymes, vitamins, and minerals. Examples of flour that is prepared to contain a relatively low amount of active enzyme are described in U.S. Pat. No. 7,258,888; and in United States Patent Publication Number 2007/0259091, the entireties of each of these documents being incorporated herein by reference.

A major, generally primary, constituent of flour is starch. The term “starch” is used in the present description in a manner consistent with its well understood and conventional meaning in the chemical and food arts. Consistent therewith, starch is a nutrient carbohydrate, e.g. of glucose (C₆H₁₀O₅)ₙ, that is found in and can be separated, in concentrated form, from biomass such as seeds, fruits, tubers, roots, and stem pith, of plants, notably in corn, potatoes, wheat, tapioca, legumes, and rice. Starch is a collection of polymeric carbohydrate molecules including a form referred to as amylose, which is a straight-chain polymer, and another form referred to as amylopectin, which is a branched-chain polymer molecule. The starch molecules are predominantly in the form of “particles” or “granules” of tightly packed collections of the starch molecules, but lower molecular weight fragments may (i.e., “damaged starch”) be also present in a flour composition, separate from the starch granules.

According to the invention, the flour component of a dough as described includes a reduced level of active carbohydrase enzyme (e.g., amylase), and a reduced level of damaged starch, relative to levels of these materials that may be present in a flour used for preparing a dough.

A flour that contains reduced active amylase enzyme can be one that has been treated to inactivate the amylase enzyme, or that has been processed by milling and separation techniques to remove a portion of the flour components that contain a relatively high amount of enzymes. The reduced level of active amylase enzyme can be measured or quantified by known methods, e.g., assay methods (tested at room temperature), examples of which are well known or commercially available. In example embodiments, a flour as part of a flour component can have a beta amylase activity, of not greater than 36 Beta amyl-3 U/g units, e.g., not greater than 28 Beta amyl-3 U/g units, or not greater than 19 Beta amyl-3 U/g units.

In addition, the flour can also contain a reduced level of damaged starch, e.g., based on a total amount of starch in the flour. For example, the dough composition can contain less than 5, 3, 2, or 1 weight percent damaged starch, based on total starch in the flour.

Optionally, as partial or full replacement of flour (i.e., flour ingredient) in a flour component, the flour component a dough as describe can contain “composite” flour or “synthetic” flour, which means a combination of a concentrated (or “isolated”) starch ingredient and a concentrated (or “isolated”) protein ingredient.

The starch ingredient can be a concentrated (or “isolated”) starch ingredient that includes a high concentration of starch, e.g., at least 70, 80, 90, 95, 98, or 99 weight percent starch based on total weight solids in the starch ingredient. The starch is mostly in granule form but the starch ingredient can also include a low or minor amount of damaged starch, e.g., less than 5, 3, 2, or 1 weight percent damaged starch based on total weight of starch in the starch ingredient. The starch may be derived from any plant or other starch source, such as from wheat, corn, potato, rice, tapioca, oat, barley, millit, bananas, sorghum, sweet potatoes, rye, as well as other cereals, legumes, and vegetables. The starch ingredient will also contain a substantially reduced (relative to a typical flour) amount of active carbohydrase enzyme.

The protein ingredient can be a concentrated (or “isolated”) protein ingredient that includes a high concentration of protein, e.g., at least 70, 80, 90, 95, 98, or 99 weight percent protein based on total weight solids in the protein ingredient. The protein may be derived from any plant or other starch source, such as from dairy (e.g., whey), soy, wheat, fish, eggs, poultry, or legume, grain, or animal sources.

A composite flour in a flour component of a dough can contain any useful relative amounts of protein ingredient and starch ingredient. Example composite flours can contain starch and protein in relative amounts that in combination are similar or comparable to relative amounts of starch and protein that would be found in a conventional flour or in a flour grain, such as wheat grain. Examples of useful relative amounts of starch and protein in a composite flour may be from 60 to 95 percent starch and from 5 to 40 percent protein, e.g., from 70 to 95 percent starch and from 5 to 30 percent protein, by weight, based on total weigh protein and starch in a composite flour.

A flour component of a dough as described can include any useful amounts of flour and composite flour (i.e., starch ingredient combined with protein ingredient). In certain embodiments, the flour component may be entirely composite flour. In other embodiments, the flour component can include a major or a minor amount of flour, and a major or a minor amount of composite flour. Example flour components can include from 0 to 85 weight percent flour (i.e., “flour ingredient,” which may optionally be processed to reduce enzyme activity, to reduce an amount of damaged starch, or both) and from 15 to 100 weight percent composite flour, based on total flour component, e.g., at least 20, 25, 30, 40, or 50 weight percent composite flour based on total flour component.

Consistent with the above description of a flour component (meaning a total amount of one or a combination of flour and composite flour as described) of an inventive dough, the flour component (and, therefore, the inventive dough) can exhibit a reduced level of active amylase enzyme. In example embodiments, a flour component can have a beta amylase activity, of not greater than 36 Beta amyl-3 U/g units, e.g., not greater than 28 Beta amyl-3 U/g units, or not greater than 19 Beta amyl-3 U/g units.

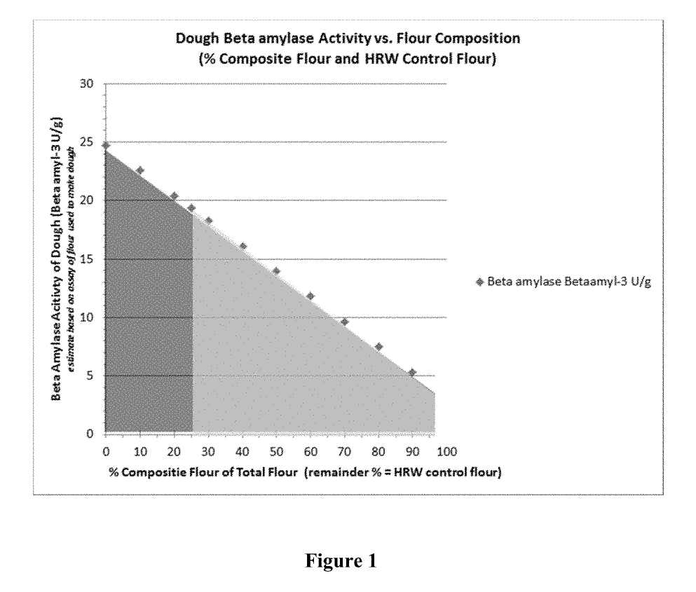

The dough, which contains flour, composite flour, or both, that have a reduced level of amylase activity, will consequently also exhibit reduced amylase activity. Referring to FIG. 1, it shows a graph of amylase activity levels of various doughs, the doughs containing “Total Flour” (meaning a flour component of the dough) that is made of ranges of amounts of flour (HRW flour, meaning hard red winter wheat flour that has not been treated to reduce amylase activity or damaged starch content) and composite flour; e.g., a flour component made of 10, 20, 30, 40, 50, 60, 70, 80, and 90 weight percent composite flour with the remaining amount of the flour component being conventional HRW. As illustrated, flour components that contain at least 20 or 25 weight percent composite flour (and 75 or 80 weight percent HRW flour) (which will have reduced amylase activity) have a desirably low level of amylase activity, e.g., below about 20 or 19 Beta amyl-3 Units per gram (U/g). Example doughs of the graph of FIG. 1 (shown with light shading) also exhibited particularly useful shelf life stability, e.g., the doughs produced a sufficiently low level of carbon dioxide to allow for the dough to be stored at a refrigerated condition (optionally in a package) without exhibiting an undesired change (increase) in dough volume, or an undesirably high amount of carbon dioxide production, as described herein.

Likewise, the flour component can also contain a reduced level of damaged starch, e.g., based on a total amount of starch in the flour. For example, the dough composition can contain less than 5, 3, 2, or 1 weight percent damaged starch, based on total starch in the flour component.

A dough of the invention includes substrate-limited yeast, e.g., maltose-negative yeast, which are not capable of fermenting part of the sugars that will be present in the dough at least during preparation of the dough, specifically maltose. Maltose that originates from damaged starch reacted with amylase enzyme in the ingredients of a dough cannot be used by the maltose-negative yeast to produce carbon dioxide. The amount of carbon dioxide produced by the maltose-negative yeast can be limited by controlling the amounts of other sugars (i.e., substrate sugars, mainly glucofructosans, e.g., sucrose, dextrose, and fructose) that are in or that become present in the dough ingredients or dough, e.g., during refrigerated storage.

Maltose-negative yeasts are known and commercially available. Referred to as “maltose-negative,” or just “MAL−,” these yeasts do not metabolize maltose, but are usually capable of metabolizing other types of sugars such as sucrose or dextrose. A number of yeasts that ferment sucrose but not maltose (“SUC+/MAL−”) are commercially available, including the following strains of Saccharomyces cerevisiae: DZ (CBS 109.90), DS 10638 (CBS 110.90), DS 16887 (CBS 111.90) V 79 (CBS 7045), and V 372 (CBS 7437). An example of MAL− yeast is a yeast product available commercially under the trade name FLEXFERM, from Lallemand, Inc. See also U.S. Pat. Nos. 5,385,742; 5,571,544; 5,540,940; 5,744,330, the entirety of each of these being incorporated herein by reference.

The yeast can be part of a yeast composition that may be in any one of various forms, such as cream yeast, compressed yeast or fresh yeast, and dried yeast, these forms having different amounts of water present. Dried yeast is available as active dry yeast (ADY) and as instant dry yeast (IDY) having moisture contents of 6 to 8 percent and 3 to 6 percent, respectively.

The amount of substrate-limited yeast in a dough as described herein can be any useful amount, e.g., an amount in a range from 0.05 to 5 weight percent based on total weight dough composition, e.g., less than 2, 1, or less than 0.5 weight percent, e.g., from 0.1 to 0.5 weight percent active yeast, on a dry yeast basis, based on total weight dough composition.

The dough may optionally contain sweetener, e.g., natural or synthetic (artificial) sweetener, in a desired amount, depending on the type of dough product. Sugar can be present to affect flavor of a dough, and can also be useful to provide desired browning of the dough surface during baking. Desirably, to avoid providing nutrients to substrate-limited yeast, the ingredients of a dough can contain not more than a small amount of sugars that are of a type that the substrate-limited yeast is capable of metabolizing. For a dough composition that contains MAL− yeast, the dough ingredients should contain a low amount of non-maltose sugars that the substrate-limited yeast can metabolize, such as sucrose, dextrose , and fructose, e.g., less than 1, 0.5, or 0.1 weight percent non-maltose sugar, based on total weight dough.

If desired, a natural sweetener that can be included in a dough can be a sugar that is of a type that the substrate-limited yeast of a dough is incapable of metabolizing, such as maltose. Maltose and maltose ingredients such as malt extract, and pre-fermented maltose, are well known and commercially available compositions that contain a high concentration of maltose, e.g., at least 60, 80, or 90 weight percent maltose based on total weight of a maltose ingredient. According to certain embodiments of doughs as described herein, maltose can be included in the dough in an amount in a range from about 1 to 5 weight percent maltose, e.g., from about 2 to 4 weight percent maltose, based on total weight dough.

A dough includes a liquid component, which, as desired, can be included as one or more of water (including ice, during processing), milk, eggs, or any combination of these. For example, water may be added during processing either as liquid water or in the form of ice, to control the dough temperature in-process. The amount of liquid component included in a developed dough composition can depend on a variety of factors including the desired moisture content and rheological properties of the dough composition. Examples of useful amounts of water (from all sources) in a developed dough composition include amounts between about 20 and about 40 weight percent water, e.g., between about 25 and about 35 weight water, based on total weight dough.

A dough composition can optionally include egg or dairy products such as milk, buttermilk, or other milk products, in either dried or liquid forms. Non-fat milk solids which can be used in the dough composition can include the solids of skim milk and may include proteins, mineral matter, and milk sugar. Other proteins such as casein, sodium caseinate, calcium caseinate, modified casein, sweet dairy whey, modified whey, and whey protein concentrate can also be used in the dough, such as in an isolated protein ingredient (e.g., as part of a composite flour (see above) or otherwise).

A dough composition can optionally include fat ingredients such as oils (liquid fat) and shortenings (solid fat). Examples of suitable oils include soybean oil, corn oil, canola oil, sunflower oil, and other vegetable oils. Examples of suitable shortenings include animal fats and hydrogenated vegetable oils. If included in a dough, fat is typically used in an amount less than about 15 or 20 percent by weight, often less than 10 or 5 percent by weight of the dough composition. In some laminated dough products such as crescents, fat content can be as high as 16 weight percent on a total weight basis. The fat is predominantly used to create discrete laminated layers.

The dough composition can further include additional flavorings, for example, salt, such as sodium chloride and/or potassium chloride; spices; flavor (e.g., vanilla, cinnamon) etc.; and particulates such as raisins, nuts, chocolate, etc.; as is known in the dough product arts. As is known, dough compositions can also optionally include other additives, colorings, and processing aids such as emulsifiers, strengtheners (e.g., ascorbic acid), preservatives, and conditioners. Suitable emulsifiers include lecithin, mono- and diglycerides, polyglycerol esters, and the like, e.g., diacetylated tartaric esters of monoglyceride (DATEM) and sodium stearoyl-2-lactylate (SSL). Acidulants commonly added to food foods include organic and inorganic acids such as lactic acid, citric acid, tartaric acid, malic acid, acetic acid, phosphoric acid, and hydrochloric acid.

Chemical leavening agents may optionally be included in a yeast-leavened dough in minor amounts, but are not required and may be absent, e.g., present at preferably less than 10, 5, 2, 1, or 0.5 percent by weight chemical leavening agent based on the total weight of leavening agent (yeast and chemical leavening agent) or may not be present at all.

Dough compositions described herein can be prepared according to methods and steps that are known in the dough and dough product arts. These can include steps of mixing or blending ingredients to a uniform dough composition, then any of folding, lapping with and without fat or oil, forming, shaping, cutting, rolling, filling, etc., which are steps well known in the dough and baking arts. The dough can be prepared, packaged, stored, and presented for sale as desired. For example, a dough may be prepared and packaged in an un-proofed condition, such as at a raw specific volume of below 1.0, e.g., in a range from 0.75 or 0.8 to 0.9, 0.95, or 1.0 cubic centimeter per gram.

Optionally, the dough may be subjected to a “preferment” step, e.g., after the dough is completed, i.e., after a final mixing step, but before the dough is further processed (e.g., by cutting, forming, or shaping) and placed in a package. A preferment step is a step during which the dough is allowed time to expand, i.e., partially proof, by action of the yeast. The yeast can metabolize and consume any amounts of substrate sugars that were present in the dough ingredients when combined, or that were produced during preparation of the dough, such as by damaged starch reacting with amylase. The preferment may be desired to develop flavor, affect dough rheology, and further reduce the amount of fermentable sugar in the dough. A preferment step generally occurs by resting the dough at an ambient or elevated temperature, e.g., from 70 to 80 degrees Fahrenheit, for a period of time in a range from 15 to 100 minutes. Dough can also be rested at refrigeration temperatures for extended periods of time, e.g., from 40 to 50 degrees Fahrenheit for up to or in excess of 6, 12, or 24 hours. While a preferment step may be useful in preparing a packaged dough product of the present description, a preferment step is not required, and example methods of preparing a packaged dough product of the invention can specifically exclude a preferment step prior to placing the dough in a package.

As described herein, the dough exhibits useful or advantageous stability during refrigerated storage. Example dough embodiments may be placed in a package immediately or soon after the dough is prepared and sized for the package, such as by cutting, flattening, rolling, etc. The dough, at that time, may preferably have a raw specific volume of below 1.0, e.g., in a range from 0.75 or 0.8 to 0.9, 0.95, or 1.0. After being placed in the package, the dough is sufficiently dimensionally stable to have a refrigerated shelf-life of at least 10, 20, or 30 days, meaning that the dough remains fresh and in a commercially presentable form (e.g., not dimensionally unstable according to this description) for this period, when stored continuously at a refrigerated temperature, e.g., 40 degrees Fahrenheit. In particular embodiments, the dough will increase in volume during such shelf life (after being placed in the package) to a volume that is is not more than two times the volume of the dough when the dough was placed in the package, e.g., to a volume that is not more than 2.0, 1.8, 1.6, or 1.5 times the volume that the dough had when the dough was placed in the package, e.g., over a period of refrigerated (40 degrees Fahrenheit) storage of at least 10, 20, or 30 days. Measured differently, preferred dough embodiments (either in a package or un-packaged) do not expand by more than 1 cubic centimeter per gram of dough, e.g., by not more than 0.8, 0.6, or 0.5 cubic centimeters per gram of dough, during a period of refrigerated (40 degrees Fahrenheit) storage of at least 10, 20, or 30 day after a final step of preparing the dough (e.g., after a final mixing, shaping, or forming step). Example doughs, whether or not packaged, may have a raw specific volume during 10, 20, or 30 days after a final step of preparing the dough, or after being placed in a package, that does not exceed 1.3, 1.2, or 1.1 cubic centimeters per gram.

A dough composition as described may be packaged or unpackaged. A useful package may be any package that can effectively contain the dough, for presentation and sale, in a cosmetically desirable fashion, and in a fashion that also maintains the freshness of the dough within the package. Example packages include low pressure or non-pressurized packages of types that are presently used for refrigerated, raw dough products. A non-pressurized container means that the packaging is not designed to produce or maintain a pressurized interior space, e.g., an interior pressure greater than approximately 1 atmosphere (absolute). Examples include plastic tubes, chubs, sleeves, form-fill containers, pouches and the like.

Optionally, the package may include an insert such as a rigid plastic tray or a slip sheet (polymeric or paper) onto which the dough may be rolled, and optionally and preferably can be vented by a pressure relief (e.g., one-way) valve that will release carbon dioxide or other gases that may be generated by the dough within the package. An example dough may be a pizza dough that is flattened onto a flexible substrate (e.g., a thin, flexible planar material such as parchment paper, a slip sheet, or a polymeric analog), the dough and substrate (e.g., slip sheet) then being rolled up into a spirally-wound, elongate product that will fit into a container such as a pouch. A slip sheet that is paper (e.g., parchment paper) can be preferred to a polymeric slip sheet, due to the ability of a paper slip sheet to be permeable to carbon dioxide or other gases that evolve from the dough during a refrigerated shelf life, thus preventing formation of bubbles or separation upon carbon dioxide buildup between the rolled substrate and the rolled dough.

Exemplary packaging materials that may be useful for non-pressurized pouch, tube, or chub packaging, can include flexible plastic materials that act as an adequate oxygen barrier, to promote storage and freshness. The packaging can be flexible, and may be prepared from materials such as paper or polymeric materials, such as polymeric (e.g., plastic) film. A polymeric film may be prepared from generally well known packaging material polymers such as different polyesters (e.g., PET), nylons, polyolefins (e.g., polyethylene), vinyls, polyalcohols, etc.

According to certain embodiments of the invention, a flexible package can be sized to accommodate the dough when inserted into the package (e.g., at a raw specific volume of not greater than about 1 cc/gram), and to allow the dough to expand to some degree, as described herein, within the package, during a refrigerated shelf life. Accordingly, the package, when the dough is initially placed therein, can include an amount of extra space at the interior of the package (i.e., headspace) in addition to the amount of internal space needed to contain the dough. The headspace may be of a volume that is about the same as the volume of the dough when placed in the package; e.g., when the dough is placed in the package, the headspace may be in a range from 0.5 to about 2.0 times the volume of the dough, e.g., from about 0.5 to about 1.5 times the volume of the dough. Thus, embodiments of the invention allow placing unproofed dough composition into a (e.g., flexible) package and allowing for a small amount of expansion of the dough within the package. A pressure relief valve can prevent gases from building up within the package, and any attendant increase in pressure within the package.

The dough, after a period of refrigerated storage in a package, can be removed from the package and baked. Preferred dough embodiments can be removed from the package and baked directly, without a resting or proofing step. The packaged dough can preferably be baked (optionally without proofing) to a baked specific volume that is in a range from 1.5 to 2.2 times the raw specific volume of the dough when removed from the package, e.g., to a baked specific volume in a range from about 1.5 to 2.5 cubic centimeters per gram.

### EXAMPLES

### Example 1

### Effect of MAL− Yeast Concentration, Pre-fermentation Step, and Percent Composite Flour in Dough on CO₂ Release Rate and Bake Performance

This Example is designed to observe how different factors affect carbon dioxide production in a dough composition during refrigeration, namely, to observe the effects of the following on carbon dioxide production: 1) the concentration of MAL− yeast, 2) the use of a pre-fermentation step to exhaust fermentable substrate sugars, and 3) the use of partial to complete replacement of a control flour with a composite flour (combination of isolated wheat starch and vital wheat gluten inherently low in amylase enzymes). The effects of these factors on bake performance were also considered.

Procedure, Materials and Methods:

Assess various combinations of flour and composite flour, over a range of MAL− yeast concentrations, to determine leavening rate upon refrigeration (+/−preferment step).

Design: 5 × 3 × 2 = 30 treatments

| | | Composite | % Mal- | Yes/No |
|---|---|---|---|---|
| Treatment | Flour (%) | Flour (%) | yeast | Preferment* |
| 1 | 100 | 0 | 0.5 | No |
| 2 | 75 | 25 | 0.5 | No |
| 3 | 50 | 50 | 0.5 | No |
| 4 | 25 | 75 | 0.5 | No |
| 5 | 0 | 100 | 0.5 | No |
| 6 | 100 | 0 | 0.5 | Yes |
| 7 | 75 | 25 | 0.5 | Yes |
| 8 | 50 | 50 | 0.5 | Yes |
| 9 | 25 | 75 | 0.5 | Yes |
| 10 | 0 | 100 | 0.5 | Yes |
| 11 | 100 | 0 | 1 | No |
| 12 | 75 | 25 | 1 | No |
| 13 | 50 | 50 | 1 | No |
| 14 | 25 | 75 | 1 | No |
| 15 | 0 | 100 | 1 | No |
| 16 | 100 | 0 | 1 | Yes |
| 17 | 75 | 25 | 1 | Yes |
| 18 | 50 | 50 | 1 | Yes |
| 19 | 25 | 75 | 1 | Yes |
| 20 | 0 | 100 | 1 | Yes |
| 21 | 100 | 0 | 1.5 | No |
| 22 | 75 | 25 | 1.5 | No |
| 23 | 50 | 50 | 1.5 | No |
| 24 | 25 | 75 | 1.5 | No |
| 25 | 0 | 100 | 1.5 | No |
| 26 | 100 | 0 | 1.5 | Yes |
| 27 | 75 | 25 | 1.5 | Yes |
| 28 | 50 | 50 | 1.5 | Yes |
| 29 | 25 | 75 | 1.5 | Yes |
| 30 | 0 | 100 | 1.5 | Yes |

*Dough held at ambient for ~20 hours prior to final shaping and freezing.

Mixing (all treatments)

Equipment: Spiral mixer (L′art du Melange)
1) Add glucose oxidase to iced water (use strainer to keep ice out of formula water)
2) Add (iced) water plus enzyme to mixing bowl
3) Add oil to water in mixing bowl
4) Add combined dry first stage ingredients to water/oil in mixing bowl
5) Mix slow for 30 sec. and fast for 5 minutes
6) Add 2nd stage dry ingredients
7) Mix slow for 30 sec. and fast for 4 minutes.

Straight Dough Process (Treatments—1, 2, 3, 4, 5, 11, 12, 13, 14, 15, 21, 22, 23, 24, 25)
1) Divided dough into 200 gram pieces and sheeted into oval/round shape using a rolling pin (final thickness ˜4-5 mm)
2) Placed sheeted pieces onto parchment paper (8″×12″) and rolled into tight rolled-cylinder format.
3) Placed rolled pieces onto trays and then into a blast freezer set at −29° F.
4) Removed samples from blast freezer after ˜1-2 hours and stored at −10° F. until packaging step.

Dough Measurements post-mixing
Placed duplicate 25 gm samples into Risograph sample jars and started collecting gas evolution data (set to collect at 10 min. intervals). The samples were held at ambient temperature ˜70° F.). The Risograph is an electronic instrument that measures gas generated by fermenting dough or chemical leavening; these are commercially sold by the National Division of TMCO, Lincoln, Nebr., U.S.A. The instrument rapidly and accurately determines the amount (e.g., in milliliters) of CO₂ per minute evolved (rate) from a sample, as well as the cumulative gas released.
Measured dough water activity (a_{w}) and pH.

Preferment Process (Treatments—6, 7, 8, 9, 10, 16, 17, 18, 19, 20, 26, 27, 28, 29, 30)
1) Divided dough into 200 gm pieces and rolled into ball shape.
2) Placed rounded dough pieces onto parchment lined baking sheets and covered with a plastic bag (placed 4 inverted cups onto the tray surface to prevent the dough from sticking to the bag upon expansion and taped bag end closed but not airtight).
3) Allowed dough to rest at room temperature (70° F.) overnight.
4) Sheeted (and degassed) the expanded dough to 4-5 mm thickness and prepared samples for freezing as described in steps 2-4 above for the straight dough process.

Packaging (FFS—Form Fill Seal, unvented package)
Dough samples packaged frozen to prevent collapse of dough structure upon vacuum/flush process.
Machine: MultiVac 540
Pouch cavity dimensions: width 2.5625″, Depth 2.5″, Length 14.3125″
Film (Curwood/Bemis)
   Formable cavity material—Curlon Grade 9531-AA
   Lid Stock—Curlam Grade 18334-K
Flushed with 60% N₂/40% CO₂ gas
   Packages labeled, weighed, and initial volumes recorded (volumetric displacement process) prior to being stored at 40° F.

Analysis

Dough—(Measurements taken immediately after final mixing step): Aw, pH, and Risograph gas evolution for duplicate 25 gm pieces for T1-T15. Data collected every 10 minutes at ambient ˜70° F.

Package—(days 0, 5, and 10): Package volume change (volumetric displacement method)

Product Evaluation—(measured at day 9, day 20, and day 30 after placing dough in package)

Dough:
Ease of un-rolling (qualitative assessment), general observations.
Dough specific volume.
Dough height (3 measurements across pad).
After baking (425° F. for 13 min. in Reel oven):
   Bake height (3 measurements across crust)
   Minolta L*, a*, b* color measurement
   Photograph
   Taste (qualitative assessment)

Results:

Out Gassing Rate

For each MAL− yeast concentration evaluated; plotted slope of linear change in package volume for pre-fermented and non-fermented sample sets vs. storage time as a function of the flour (control HRW) used in formula.

Observations: Outgassing rate is a positive linear function of the percent control flour present in the dough. Conversely, as the percent of composite flour increases, outgassing declines in a linear fashion. One can infer from these observations that the flour is providing additional substrate to the yeast by either i) Increasing the concentration of hydrolytic amylase enzyme present in the dough, by providing damaged starch for the amylases to convert into fermentable sugars, or both. At the low MAL− yeast concentration of 0.5%, there is little difference in gas release rate between the non-fermented and fermented sample sets. The pre-fermentation step with 0.5% MAL− yeast did not exhaust the fermentable substrate sugar in the dough. See FIG. 2 (Plot 1: 0.5% MAL− Yeast Rate vs % Control HRW Flour).

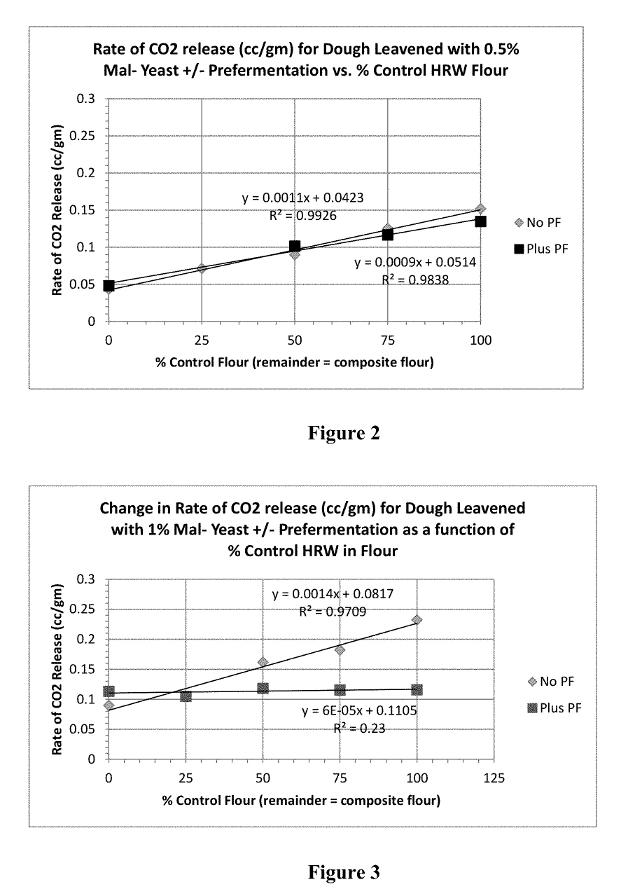

Looking at FIG. 3 (Plot 2: 1.0% MAL− Yeast Rate vs % Control HRW Flour), at 1% MAL− yeast, a positive linear increase in outgassing rate is observed as the amount of control HRW flour in the “no pre-ferment” sample set increases (similar to the 0.5% MAL− yeast results described earlier). Unlike the 0.5% MAL− results, however, when the 1% MAL− yeast sample set was subjected to a pre-fermentation step, the CO₂ release rate did not increases but rather remained fairly low, constant, and independent of flour composition. One can hypothesize that the observed low baseline CO₂ release rate in the pre-fermented samples is the result of the continued hydrolysis of starch oligosaccharides over storage time. Lastly, the observation that the pre-fermented CO₂ release rate remains fairly low and consistent regardless of the flour composition indicates that a majority of the fermentable substrate is exhausted during the pre-ferment step.

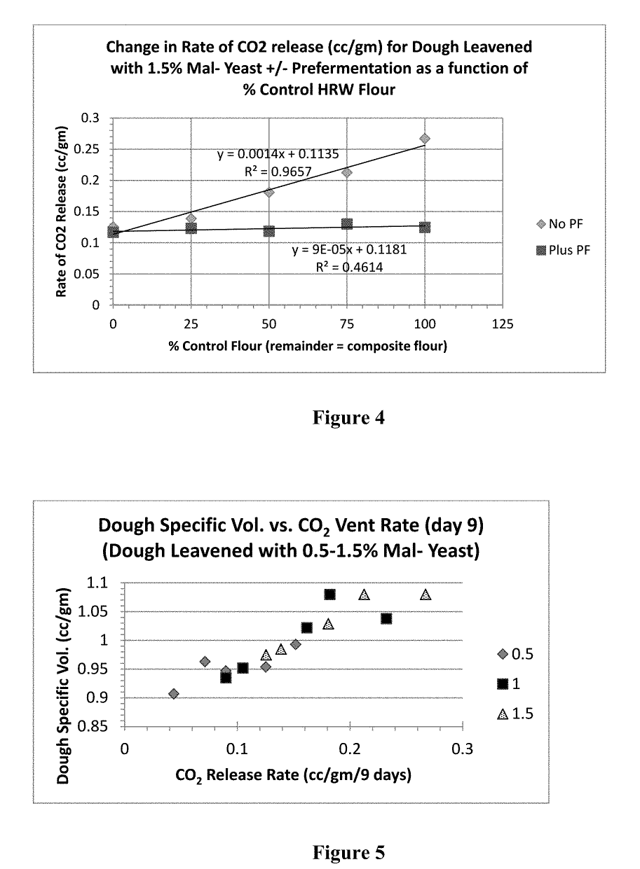

Looking now at FIG. 4 (Plot 3: 1.5% MAL− Yeast Rate vs % Control HRW Flour), at 1.5% MAL− yeast, a positive linear increase in out gassing rate is observed as the amount of flour increases in the “no pre-ferment” sample set (similar to previous results at 0.5 and 1% MAL− yeast). As was observed with the 1.0% MAL− yeast results, when the 1.5% MAL− yeast sample set was subjected to a pre-fermentation step, the CO₂ release rate remained constant and independent of flour composition. One can hypothesize that the observed low baseline CO₂ release rate in the pre-fermented samples is the result of the hydrolysis of starch oligosaccharides over time (see earlier discussion). Lastly, the observation that the pre-fermented CO₂ release rate remains fairly low and consistent regardless of the flour composition indicates that a majority of the fermentable substrate is exhausted during the pre-ferment step.

Referring now to FIG. 5 (Plot 4: Dough Specific Vol. as a Function of CO2 Release Rate-Day 9): After 9 days storage, a linear increase in dough specific volume is observed with increasing CO₂ release rates. The relationship is independent of the means by which CO₂ release rate was achieved. That is to say, regardless of various combinations of % MAL− yeast and % control flour, comparable CO₂ release rates resulted in comparable dough specific volumes.

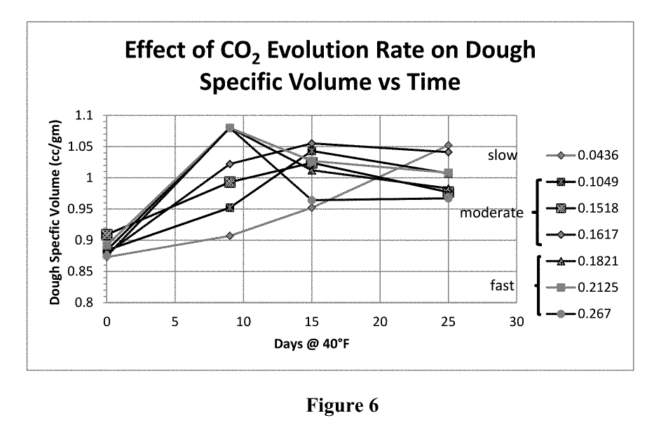

Referring to FIG. 6 (Plot 5: Effect of CO₂ Evolution Rate of Dough Specific Volume vs Time): A sampling of CO₂ evolution rates (cc CO₂/gm/day at 40° F.) shows three distinct dough specific volume profiles vs storage time (not all treatments shown for ease of comparison). At higher CO₂ evolution rates (>0.1821 cc/gm/day) (i.e., 0.1821, 0.2125, 0.267 cc/gm/day), a rapid increase in specific volume over the initial 10 days of storage to >1.05 cc/gm is observed, followed by a decline to 0.96-1.02 between days 10 and 15. For CO₂ evolution rates ranging from 0.1049-0.1617 cc/gm/day, one observes a more moderate increase in dough specific volume through day 15 followed by a plateau/stabilization in dough specific volume ranging from 0.96-1.04 cc/gm between days 15 and 25. At the lowest CO₂ evolution rates observed (0.0436 cc/gm/day), one observes a more linear and less rapid increase in dough specific volume over time, with an end specific volume of 1.05 cc/gm. Generally speaking, the less rapid the CO₂ evolution rate, the less likely dough specific volumes will decline upon reaching a maximum specific volume value.

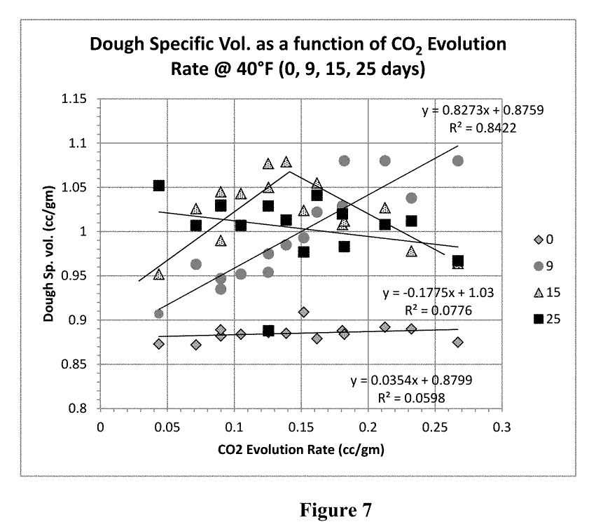

Referring to FIG. 7 (Plot 6: Dough Specific Volume vs. CO₂ Release Rate at 0-25 days): At time=0 all dough densities are comparable (no opportunity of out gassing as the dough is frozen prior to packaging). After 9 days, a positive linear relationship is observed between dough specific volume and CO₂ evolution rate (see plot 6 also). At 15 days, peak in dough specific volume is observed followed by a decline, with increasing evolution rate (dough structure can't maintain expanded volume at higher CO₂ evolution rates >0.14 cc/gm). At 25 days, a steady specific volume is reached at ˜1 cc/gm across all CO₂ evolution rates (expanded dough is no longer capable of increase in volume).

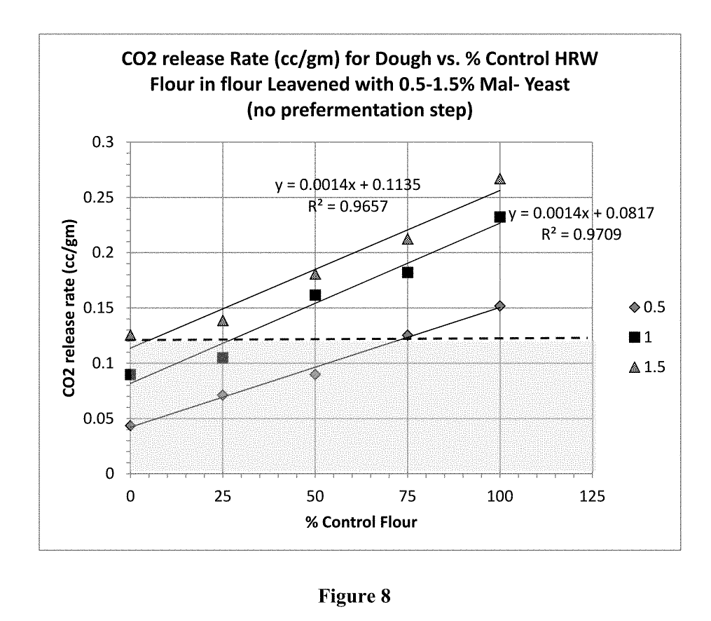

Referring to FIG. 8 (Plot 7: CO₂ Release Rate vs. % Control Flour at 0.5-1.5% MAL− Yeast): Combining the no preferment CO₂ release rates curves from plots 1-3, and shading the CO₂ release rate area (below the dashed line) that results in minimal/reduced dough structure collapse, identifies MAL− yeast concentration and flour combinations that are highly desirable for stable refrigerated dough structure. Based on this plot and other observations described earlier, 0.5% MAL− yeast concentration provides the highly desirable result over a range of control HRW flour compositions (0-75% control flour/100-25% composite flour) resulting in CO₂ evolution rates≦0.12-0.13 cc/gm associated more stable dough specific volumes. 1% and 1.5% MAL− yeast concentrations can provide desired results over reduced ranges of flour per composite flour.

Summary:

A pre-fermentation step of ≧20 hours at ambient temperatures, will exhaust a majority of the fermentable substrate that is generated in a dough by the enzymatic hydrolysis of damaged starch, during preparation. As a result, CO₂ gas evolution rate upon refrigeration is relatively flat; the pre-fermented dough systems 1) can outgas very little over storage time, and 2) expand only slightly upon baking due to a lack in gas holding capacity and collapse of nucleated structure.

When no pre-fermentation step is performed, there is a positive and linear relationship between MAL− yeast concentration and CO₂ release rate (more yeast=greater CO₂ evolution rate). Moreover, for a given MAL− yeast concentration, outgassing rate is a positive linear function of the amount of control HRW flour (on a percentage basis) present in the dough, relative to composite flour. Conversely, as the amount of composite flour (concentrated protein ingredient and concentrated starch ingredients, replacing an amount of the flour) increases, replacing a portion of the flour, outgassing declines in a linear fashion. The flour appears to be providing additional substrate to the yeast by either i) increasing the concentration of hydrolytic amylase enzyme present in the dough, or ii) providing more damaged starch for the amylases to convert into fermentable sugars.

1. A packaged raw dough product comprising a dough composition in a package, the dough composition comprising:
from 30 to 70 weight percent flour component based on total weight dough composition,
active maltose negative yeast in an amount in a range from 0.1 to 5 weight percent based on total weight dough composition and on a dry yeast basis,
wherein the raw dough exhibits carbohydrase enzyme activity below 20 Beta amyl-3 U/g.

2. A dough product of claim 1 wherein the flour component comprises:
from 0 to 85 weight percent flour based on total flour component, and
from 15 to 100 weight percent composite flour based on total flour component, the composite flour comprising:
isolated starch ingredient, and
isolated protein ingredient.

3. A packaged dough product of claim 2 wherein the flour component comprises:
from 5 to 80 weight percent flour based on total flour component, and
from 20 to 95 weight percent composite flour based on total flour component.

4. A packaged dough product of claim 2 wherein the isolated starch ingredient contains less than 5 weight percent damaged starch, based on total weight starch isolated starch ingredient.

5. A packaged dough product of claim 2 wherein the composite flour exhibits amylase activity below 36 Beta amyl-3 U/g.

6. A packaged dough product of claim 1 wherein the dough does not expand more than 1 cc/gram during refrigerated storage for a period of at least 30 days, after being placed into the package.

7. A packaged dough product of claim 1 wherein the dough has a raw specific volume in a range from 0.75 to 0.95 cubic centimeters per gram when placed in the package.

8. A packaged dough product of claim 1 wherein the raw specific volume of the dough does not exceed 1.3 cubic centimeters per gram during 30 days of refrigerated storage at 40 degrees Fahrenheit.

9. A packaged dough product of claim 7 wherein after 30 days of refrigerated storage at 40 degrees Fahrenheit, the dough can be removed from the package and baked without proofing to a baked specific volume that is in a range from 1.5 to 2.2 times the raw specific volume of the dough when removed from the package.

10. A packaged dough product of claim 1 wherein the package is vented, non-pressurized, and includes headspace having a volume that is at least 50 percent of the volume of the dough.

11. (canceled)

12. (canceled)

13. A raw dough composition comprising:
from 30 to 70 weight percent flour component based on total weight dough composition, the flour component comprising:
from 0 to 80 weight percent flour based on total flour component, and
from 15 to 100 weight percent composite flour based on total flour component, the composite flour comprising:
isolated starch ingredient, and
isolated protein ingredient, and
active maltose negative yeast in an amount in a range from 0.1 to 5 weight percent based on total dough composition,
wherein the raw dough exhibits carbohydrase enzyme activity below 20 Beta amyl-3 U/g.

14. A composition of claim 13 wherein the flour component comprises
from 5 to 80 weight percent flour and
from 20 to 95 weight percent composite flour,
and wherein the flour component exhibits amylase activity below 36 Beta amyl-3 U/g.

15. A composition of claim 14 wherein the flour component exhibits amylase activity below 36 Beta amyl-3 U/g.

16. A composition of claim 13 wherein the isolated starch ingredient comprises less than 5 weight percent damaged starch, based on total weight isolated starch ingredient.

17. A composition of claim 1 wherein the dough does not expand more than 1 cc/gram during refrigerated storage of 40 degrees Fahrenheit for a period of at least 30 days, after the dough is prepared.

18. A composition of claim 13 wherein the composite flour comprises:
from 60 to 95 weight percent isolated starch ingredient, and
from 5 to 40 weight percent isolated protein ingredient,
based on total weight isolated starch ingredient and isolated protein ingredient.

19. A composition of any of claim 13 comprising from 0.1 to 4 weight percent maltose based on total weight dough composition.

20. (canceled)

21. (canceled)

22. A composition of claim 13 wherein the dough has a carbon dioxide release rate of not greater than 0.13 cubic centimeters per gram per day, measured at 70 degrees Fahrenheit.

23. A packaged dough product of claim 1 wherein the dough has a carbon dioxide release rate of not greater than 0.13-cubic centimeters per gram per day, measured at 70 degrees Fahrenheit.

24. A method of preparing a refrigerated, packaged dough product, the method comprising:
providing a raw dough composition of claim 13,
placing the raw dough composition in a package, and
storing the packaged raw dough, with refrigeration, for a refrigeration period of at least 30 days.

25. (canceled)

26. (canceled)
